(19) United States
(12) Patent Application Publication
(10) Pub. No.: US 2008/0296334 A1
(43) Pub. Date: Dec. 4, 2008

(54) Portable aviation clamp

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/809,281

(22) Filed: May 31, 2007

(51) Int. Cl. B60R 11/00

(52) U.S. Cl. 224/558; 224/571

(57) ABSTRACT

An aviation clamp device formed of a substantially rigid elongated jaw structure formed with an open throat portion formed between spaced apart and relatively angularly canted opposing drive and anvil plates and a backing plate and having an elongated mouth opening thereinto between the opposing drive and anvil plates and partially extending around peripheries thereof to the backing plate, the drive plate being formed with a pair of threaded apertures therethrough spaced adjacent to opposite ends thereof, and a ball-end coupler formed of a resiliently deformable part-spherical head projected from one of the drive and anvil plates on a substantially rigid reduced diameter stem relatively upstanding thereon; and a plurality of threaded thumb screws each structured for cooperating with one of the threaded apertures by threading therethrough from an external surface of the elongated jaw structure into the throat portion thereof.

### FIELD OF THE INVENTION

The present invention relates generally to clamps for holding portable devices, and in particular to portable clamps for use with ball-and-socket connectors in aviation environments.

### BACKGROUND OF THE INVENTION

Display space on the control panel of an aircraft is limited by the physical dimensions of the cockpit and the number of instruments displayed on the control panel is limited by the physical size of the instrument's display which must be large enough to be easily read by the crew. These control panel space constraints limit the number of instruments available on the control panel of any aircraft, from the small private airplane to the large commercial airliners. For example, current private airplanes are typically equipped with a standard avionics package that includes a pair of radios and a pair of navigation receivers. The control panel is filled with engine instrument displays, airplane control displays and navigation/voice radio displays. No room exists on the control panel for map displays, such as those that use information from a global positioning system (GPS). Although larger and carrying more instruments, commercial airliners suffer similar space constraints. Similar constraints also limit the number of instruments which can be displayed on the control panel of a land or water-based vehicle, i.e., the dash board of an automobile or a boat. In such situations display space is a premium.

Because display space is a premium, instrument panels generally do not provide space for redundancy, i.e., back-up displays for any or all flight critical instruments. Nor is space available for additional flight information. Thus, as current technology provides new information sources, for example, the GPS position information, the instrument display must compete with the existing instruments for space on the control panel. Some of the new technology products provide critical flight safety information which must somehow be provided to the crew. Additionally, pilots must routinely consult pre-flight check lists, flight charts, approach plates, and other flight information documents, while operating the aircraft. For example, during landing pilots generally prefer to have an approach plate or map in plain view for easy reference.

Examples of efforts to provide additional display space include such products as so called “lap boards.” Lap boards, as described in U.S. Design patent No. 317,788, AVIATION LAP BOARD, are literally boards strapped to the pilot's leg which provide an extra flat surface for holding maps for reference during flight or landing. However, the pilot is forced to continually look down at the lap board to read the documents which interrupts attention to the instruments and windshield. Another example is the clip board mounted to the column of the aircraft control yoke described in each of U.S. Pat. No. 4,969,623, FLIGHT DOCUMENTS ORGANIZER and U.S. Pat. No. 5,441,229, HOLDER FOR ASSEMBLAGE OF PILOT FLIGHT CHARTS. U.S. Pat. No. 3,809,338, TIMER AND APPROACH PLATE HOLDER FOR AIRCRAFT describes such a clip board, incorporating a chronometer, which mounts by a spring clip onto the yoke column. U.S. Pat. No. 5,222,690, VEHICULAR DESK OR INFORMATION DISPLAY, describes another such clip board, incorporating a video display, which again mounts by a clamp onto the yoke column. Other clip boards are know which are designed to mount directly onto the control yoke, either as a removable attachment or as an integral part of the control yoke (no examples found). The described control column and yoke mounted clip boards provide the pilot with an easily viewable display.

Presently, pilots often temporarily mount the approach map, or another aeronautical chart or flight information document, like a recipe card on the clip board. However, while pilots need to comfortably and effectively consult these documents in a timely fashion as the need arises, such maps and documents tend to obscure other critical flight instruments and engine and fuel monitoring instruments on the control panel. Also, these documents tend to become awkward and unwieldy when too large to conveniently fit on the clip board. Some further disadvantages of control column mounted clip boards are that they are costly for many private pilots and that small aircraft manufacturers cannot provide these useful displays because their temporary nature does not allow for certification.

Other examples of efforts to provide additional display space include suction cup clamp devices. Suction cup clamp devices, as described in U.S. Pat. No. 6,666,420, SUCTION CUP HAVING COMPACT AXIAL INSTALLATION AND RELEASE MECHANISM, invented by the inventor of the disclosed invention, which is incorporated herein by reference, are clamps that provide additional display space by mounting to smooth cockpit surfaces, such as the front or side windscreens. Suction cup clamp devices may include means for mounting the resiliently compressible ball-shaped coupler described in U.S. Pat. No. 5,845,885, UNIVERSALLY POSITIONABLE MOUNTING DEVICE, invented by the inventor of the disclosed invention, which is incorporated herein by reference. However, suction cup clamp devices may have limited value in mounting electronics devices as, under certain circumstances, ambient light tends to wash out images on display screens, especially liquid crystal display (LCD) screens.

Thus, to date, whether an air, land or water-based vehicle, cockpit display space remains severely limited.

### SUMMARY OF THE INVENTION

The present invention is a novel clamp device that overcomes limitations of the prior art for providing additional display volume for cockpit instrumentation, and a method of operating the novel clamp device, which includes a method of operating the novel clamp device for other useful purposes.

According to one aspect of the novel clamp device, the clamp device is formed of a substantially rigid elongated jaw structure formed with an elongated mouth opening thereinto formed between opposing drive and anvil plates spaced apart by an opposing backing plate. The drive plate is formed with a plurality of threaded apertures therethrough spaced along the mouth opening, and a ball-end coupler projected from one of the drive and anvil plates. A plurality of threaded fasteners is each structured for threading through one of the threaded apertures.

According to another aspect of the novel clamp device, the ball-end coupler further includes a resiliently deformable part-spherical head formed on a substantially rigid reduced diameter stem relatively upstanding on the one of the drive and anvil plates.

According to another aspect of the novel clamp device, the stem portion of the ball-end coupler is formed adjacent to a lip portion of the one of the drive and anvil plates adjacent to the mouth opening.

According to another aspect of the novel clamp device, the stem portion of the ball-end coupler is formed substantially centered relative to the mouth opening.

According to another aspect of the novel clamp device, the one of the drive and anvil plates having the ball-end coupler projected therefrom further includes a protrusion projected from the lip portion thereof both substantially coplanar therewith and substantially centered relative to the mouth opening; and the stem portion of the ball-end coupler is formed partially on the lip portion and partially on the protrusion projected therefrom.

According to another aspect of the novel clamp device, two or more of the plurality of threaded apertures are further formed adjacent to a lip portion of the drive plate.

According to another aspect of the novel clamp device, the ball-end coupler is formed on the drive plate.

According to another aspect of the novel clamp device, the ball-end coupler is formed on the anvil plate.

According to another aspect of the novel clamp device, the drive and anvil plates are further relatively angularly canted.

A method of operating the novel clamp device is provided for mounting an external object for viewing, the method includes fitting an elongated throat portion of a substantially rigid elongated jaw structure over an edge protrusion having opposing first and second surfaces spaced apart by a thickness less than an elongated opening into the throat portion, including positioning a substantially rigid anvil plate adjacent to a first surface of the edge protrusion, and positioning a rigidly interconnected opposing substantially rigid drive plate adjacent to a second surface thereof substantially opposite from the first surface, with one of the drive and anvil plates having a first ball-end coupler projected therefrom and formed of a substantially rigid reduced diameter stem relatively upstanding thereon and a resiliently deformable part-spherical head formed on the stem distal from the jaw structure. From an exterior surface of the drive plate opposite from the first surface of the edge protrusion, threading at least two threaded fasteners through cooperating threaded apertures formed in the drive plate and into contact with the first surface of the edge protrusion. On an external object intended for viewing, mounting a second ball-end coupler having a relatively upstanding substantially rigid reduced diameter stem with a resiliently deformable part-spherical head formed thereon distal from the external object. On the respective part-spherical heads of the first and second ball-end couplers, rotatably coupling respective first and second socket ends of a split-arm socket assembly. Rotatably adjusting a position and orientation of the external object for positioning a viewable portion thereof in a position suitable for viewing. By tightening a clamping mechanism relative to the split-arm socket assembly, interlocking each of the first and second socket ends with the respective part-spherical heads of the first and second ball-end couplers for retaining the selected positioning of the viewable portion of the external object.

According to another aspect of the method of operating the novel clamp device, mounting a second ball-end coupler on an external object further includes mounting the second ball-end coupler on a tray structured for holding a portable electronic instrument having a lightable display screen.

According to another aspect of the method of operating the novel clamp device, fitting an elongated throat portion of a substantially rigid elongated jaw structure over an edge protrusion further includes fitting the elongated throat portion over an edge protrusion of a cockpit dashboard.

According to another aspect of the method of operating the novel clamp device, rotatably adjusting a position and orientation of the external object for positioning a viewable portion thereof in a position suitable for viewing further includes positioning the external object relative to the cockpit dashboard opposite from one or more windscreens of a cockpit containing the dashboard.

According to another aspect of the method of operating the novel clamp device, the cockpit dashboard is further formed of a first surface adjacent to the one or more windscreens and a second surface opposite and spaced away from therefrom, the first surface of the cockpit dashboard further including the first surface of the edge protrusion, and the second surface of the cockpit dashboard further including the second surface of the edge protrusion. With the drive plate further comprising the first ball-end coupler projected therefrom and the threaded fasteners being threaded into the cooperating threaded apertures formed therein, orienting the elongated jaw structure with the anvil plate adjacent to the first surface of the edge protrusion adjacent to the one or more windscreens, and the drive plate and the first ball-end coupler projected therefrom the adjacent to second surface of the edge protrusion opposite and spaced away therefrom. Threading the threaded fasteners through the cooperating threaded apertures formed in the drive plate and into contact with the second surface of the edge protrusion.

According to another aspect of the method of operating the novel clamp device, fitting an elongated throat portion of a substantially rigid elongated jaw structure over an edge protrusion further includes fitting the elongated throat portion over an edge protrusion of a table, instead of a cockpit dashboard.

According to another aspect of the method of operating the novel clamp device, fitting an elongated throat portion of a substantially rigid elongated jaw structure over an edge protrusion further includes fitting the elongated throat portion over an edge protrusion of a tray table structured for folding relative to a seat back of a vehicle seat, instead of just any table.

According to another aspect of the method of operating the novel clamp device, the tray table is further formed with a first surface facing generally toward the seat back and a second surface opposite from the first surface and facing generally away from the seat back, the first surface of the foldable tray table further including the first surface of the edge protrusion, and the second surface of the foldable tray table further including the second surface of the edge protrusion. With the drive plate further comprising the first ball-end coupler projected therefrom and the threaded fasteners being threaded into the cooperating threaded apertures formed therein, orienting the elongated jaw structure with the anvil plate adjacent to the first surface of the edge protrusion facing generally toward the seat back, and the drive plate and the first ball-end coupler projected therefrom the adjacent to second surface of the edge protrusion opposite and spaced away therefrom and facing generally away from the seat back. Threading the threaded fasteners through the cooperating threaded apertures formed in the drive plate and into contact with the second surface of the edge protrusion. Folding the foldable tray table relative to the seat back with the first surface of the foldable tray table facing inwardly toward and in substantially contact with the seat back, and the second surface thereof facing outwardly therefrom. Securing the foldable tray table relative to the seat back with the drive plate further includes the first ball-end coupler projected therefrom substantially outwardly of the second surface of the foldable tray table and external of the seat back.

According to another aspect of the method of operating the novel clamp device, the seat back further includes a recess formed therein, the recess being sized to admit the tray table thereinto with external peripheral edges thereof being spaced away from internal peripheral edges of the recess. The tray table is further formed as a tray table that is foldable into the recess formed in the seat back with first surface facing generally toward the seat back and fitting into the recess formed therein and the second surface opposite from the first surface and facing generally away from the seat back. Folding the foldable tray table relative to the seat back further includes folding the foldable tray table into the recess formed in the seat back with the first surface of the foldable tray table facing into the recess, and the second surface thereof facing outwardly therefrom, the anvil plate being positioned in the recess between the first surface of the tray table and an opposing surface of the seat back, and a backing plate of the elongated jaw structure between the drive and anvil plates thereof being positioned between the external peripheral edges of the foldable tray table and the internal peripheral edges of the recess. Securing the foldable tray table relative to the seat back further includes securing the foldable tray table substantially within the recess.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view illustrating a novel clamp device and showing an example of a method of operating the novel clamp device disclosed herein;

FIG. 2 is a side view more clearly showing the novel clamp device and the example of a method of operating the device, as illustrated in FIG. 1;

FIG. 3 is a bottom perspective view looking up at the novel clamp device and the example of a method of operating the device, as illustrated in FIG. 1;

FIG. 4 is a perspective view illustrating the novel clamp device mounted on the edge protrusion of a cockpit dashboard with a ball-end coupler thereof oriented downward into an area shadowed by the dashboard;

FIG. 5 is a perspective view illustrating the novel clamp device mounted on the edge protrusion of a cockpit dashboard with a ball-end coupler thereof oriented upward into an area above the dashboard;

FIG. 6 is a top elevation view of the novel clamp device having a pair of thumb screws removed for clarity, and showing a pair of threaded holes formed in a portion thereof on opposites sides of a ball-end coupler having a resiliently deformable part-spherical head;

FIG. 7 is a back elevation view of the novel clamp device including the pair of thumb screws;

FIG. 8 is a side elevation view of the novel clamp device including the pair of thumb screws;

FIG. 9 is a bottom elevation view of the novel clamp device including a pair of threaded holes formed in a portion thereof opposite from the ball-end coupler, this pair of threaded holes being either in combination with, or in substitution for, the threaded holes formed on either side of the ball-end coupler;

FIG. 10 is a back elevation view of the novel clamp device including a pair of thumb screws threaded into the pair of threaded holes formed opposite from the ball-end coupler;

FIG. 11 is an opposite side elevation view of the novel clamp device including a pair of thumb screws threaded into the pair of threaded holes formed opposite from the ball-end coupler;

FIG. 12 illustrates another method of operating the novel clamp device as an aviation clamp for use with a fold-out tray table in a deployed configuration relative to a seat back of a forward seat, for example an airplane seat, although the this is optionally the forward seat of a modern automobile or pleasure boat;

FIG. 13 is a front view of the novel clamp device secured by the thumb screws to an edge portion of the deployed fold-out tray table, as illustrated in FIG. 12;

FIG. 14 illustrates another method of operating the novel clamp device as an aviation clamp for use with a fold-out tray table while stored in an upright and locked configuration relative to the seat back of the forward seat; and

FIG. 15 is a front view of the novel clamp device secured by the thumb screws to an edge portion of the deployed fold-out tray table while stored in its upright and locked position relative to the seat back, as illustrated in FIG. 14.

### DETAILED DESCRIPTION OF PREFERRED EMBODIMENT

In the Figures, like numerals indicate like elements.

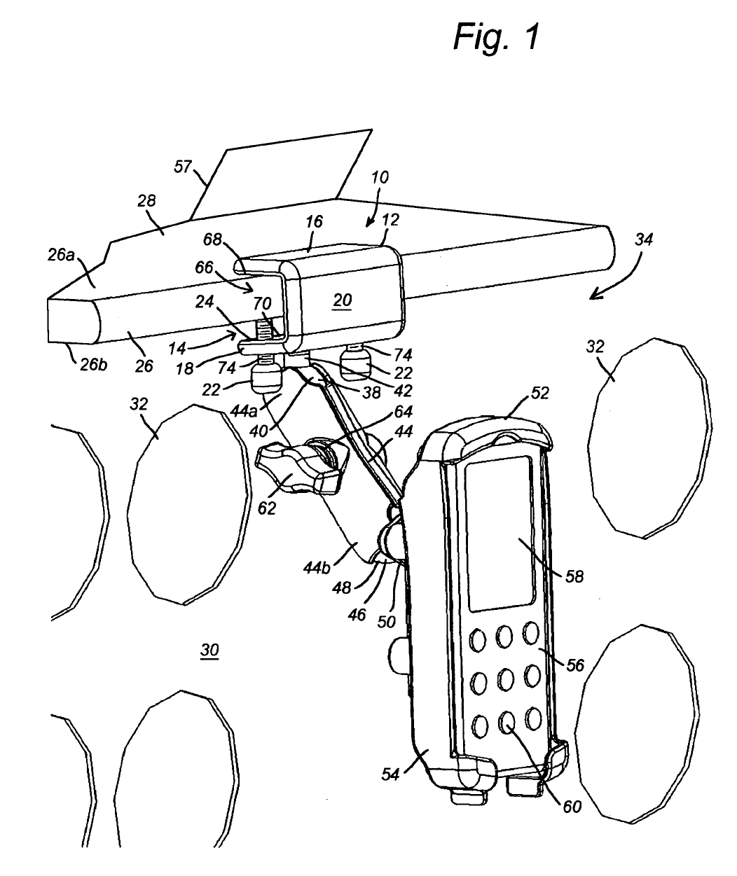

FIG. 1 is a perspective view showing an example of a method of operating a novel clamp device 10 of the type disclosed herein. The clamp device 10 is formed of a substantially rigid elongated jaw portion 12 forming an elongated and substantially uniform mouth opening 14 thereinto between opposing upper and lower plates 16 and 18 spaced apart by an opposing backing plate portion 20. The upper and lower plates 16, 18 and backing plate 20 are illustrated here by example and without limitation as substantially identical uniformly long, flat and relatively thin rigid plates. The backing plate 20 is optionally a thicker plate than the upper and lower plates 16, 18 and may be curved, without deviating from the scope and intent of the present invention. A pair of thumb screws 22 is spaced apart along the elongated jaw portion 12. The thumb screws 22 are threaded into the mouth opening 14 adjacent to an outer lip portion 24 of the lower plate 18. The lower plate 18 having the thumb screws 22 thus operates as a drive plate, while the opposing upper plate 16 operates as an anvil. The jaw portion 12 of the clamp device 10 is, for example, fit over any jutting structure of the vehicle which the mouth opening 14 is sized to receive thereinto. By example and without limitation, the mouth opening 14 is fit over an edge protrusion 26 of a cockpit dashboard 28 jutting beyond and overhanging an instrument panel 30, as is common in boats, planes and automobiles to shade instruments 32 from dome lights inside the vehicle cockpit. The dashboard 28 is typically at or below window level so that the edge protrusion 26 also shades the instrument panel 30 from ambient sunlight. The instrument panel 30 and instruments 32 mounted thereon are thus in an area (generally indicated at 34) of the cockpit normally substantially cast into shadow by the overhanging edge protrusion 26 of the dashboard 28.

A ball-end mount or “coupler” 38 with a resiliently deformable part-spherical head 40 and formed thereon is extended from the lower plate 18 on a reduced diameter columnar stem or “neck” 42 relatively upstanding thereon adjacent to the outer lip portion 24 between the thumb screws 22. Positioning the ball-end coupler 38 on the same lower plate 18 with the thumb screws 22 is not a necessary requirement of the clamp device 10; however, such relative positioning ensures the thumb screws 22 will be available for tightening when the ball-end coupler 38 is positioned in a useful place relative to the dashboard 28 or other available vehicle cockpit structure. For example, the upper plate 16 is optional slipped into a narrow slot between a rigid pocket panel and a door panel that may be wide enough to admit the slim upper plate 16, but too narrow to admit the longer thumb screws 22 or the users' digits for tightening them. Thus, colocating the ball-end coupler 38 in common with the thumb screws 22 on the same lower plate 18 is only the most versatile configuration of the clamp device 10. Furthermore, positioning the ball-end coupler 38 adjacent to the outer lip portion 24 of the lower plate 18 is not a necessary requirement of the clamp device 10; however, such relative positioning ensures the ball-end coupler 38 is removed as far as possible into the shadowed area 34 cast by the edge protrusion 26 of the cockpit dashboard 28.

The ball-end coupler 38 is, by example and without limitation, the coupler having the resiliently deformable part-spherical head as described in U.S. Pat. No. 5,845,885, which is incorporated herein by reference. Any of the hand held portable instruments or documents, such as flight information documents, useful to a boat, plane or automobile pilot may be usefully suspended from the clamp device 10. By example and without limitation, a substantially rigid split-arm socket assembly 44 of the type disclosed by example and without limitation in U.S. Pat. No. 5,845,885, which is incorporated herein above by reference, is rotatably coupled at a first socket end 44a to the part-spherical head 40 of the coupler 38 portion of the clamp device 10. A second socket end 44b of the split-arm socket assembly 44 is coupled to a second resiliently deformable part-spherical head 46 of a second ball-end mount or coupler 48 which is extended from a second reduced diameter stem or “neck” 50 relatively upstanding on a useful cockpit accessory 52, illustrated here by example and without limitation as an instrument tray 54 holding a portable electronic instrument 56, such as a GPS.

The novel clamp device 10 is, by example and without limitation, clamped to the edge protrusion 26 of the cockpit dashboard 28 with the ball-end coupler 38 projected into the shadowed area 34 cast by the edge protrusion 26. Furthermore, the first and second socket ends 44a, 44b of the split-arm socket assembly 44 cooperate with the first and second ball-end couplers 38, 48, respectively, to position the instrument tray 54 below level of a windscreen 57. Cooperation of the ball-end coupler 38 of the clamp device 10 with the split-arm socket assembly 44 and second ball-end coupler 48 furthermore permits positioning of the instrument tray 54 such that view of the instruments 32 is not obscured. With the instrument tray 54 so positioned relative to the dashboard edge protrusion 26, the position and orientation of the instrument 56 are adjusted until a lightable display screen 58 and keypad 60 (if present) of the instrument 56 are appropriately positioned in the shadowed area 34 cast by the cockpit dashboard 28 yet out of line-of-sight of instruments 32 on the instrument panel 30, and the display screen 58 and keypad 60 (if present) are appropriately oriented for viewing. The display screen 58 and keypad 60 (if present) are thus cast into shadow that ambient light does not wash out images displayed thereon. The instrument 56 is thus readable at a glance, even when the display screen 58 is of the LCD variety, but does not interfere with viewing the permanent cockpit instruments 32.

When the instrument 56 is appropriately positioned with the display screen 58 and keypad 60 (if present) in the shadowed area 34 cast by the cockpit dashboard 28, a knob 62 portion of a clamping mechanism 64 is tightened relative to the split-arm assembly 44, which effectively interlocks its first and second socket ends 44a, 44b with the first and second ball-end couplers 38, 48, respectively, to retain the selected positioning.

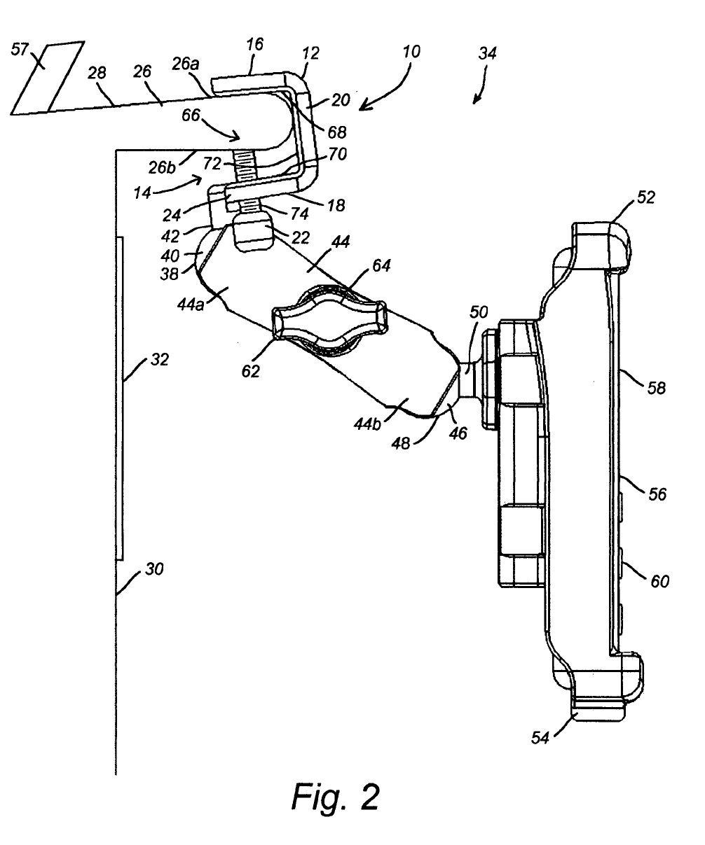

FIG. 2 is a side view more clearly showing the clamp device 10 clamped to the edge protrusion 26 of the cockpit dashboard 28 with the ball-end coupler 38 projected into the shadowed area 34 of the cockpit. As illustrated here, while not a necessary requirement of the clamp device 10, relative positioning the ball-end coupler 38 adjacent to the outer lip portion 24 of the lower plate 18 ensures the ball-end coupler 38 is removed as far as possible into the shadowed area 34 cast by the edge protrusion 26 of the cockpit dashboard 28. Furthermore, colocating the ball-end coupler 38 in common with the thumb screws 22 on the same lower plate 18 is illustrated here as being unnecessary to operation of the clamp device 10. However, such common positioning of the ball-end coupler 38 with the thumb screws 22 remains the most versatile configuration of the clamp device 10.

Here, the clamp device 10 is shown more clearly having the mouth opening 14 of the jaw portion 12 wrapped around the cockpit dashboard 28 so the edge protrusion 26 is extended deep into a substantially rectangular throat portion 66 formed between respective substantially planar inner surfaces 68 and 70 of the upper and lower jaw plates 16 and 18. The dashboard edge protrusion 26 is shown here butted against a substantially planar inner surface 72 of the backing plate portion 20. The upper plate 16 of the clamp device 10 is shown more clearly having the inner jaw surface 68 secured against an upper surface 26a of the cockpit dashboard edge protrusion 26. Threaded shafts 74 of the thumb screws 22 inserted through the lower plate 18 are driven against an under surface 26b of the cockpit dashboard edge protrusion 26 to secure the inner jaw surface 68 of the upper plate 16 against the upper cockpit dashboard edge protrusion surface 26a for holding the clamp device 10 in the selected position relative to the cockpit dashboard 28.

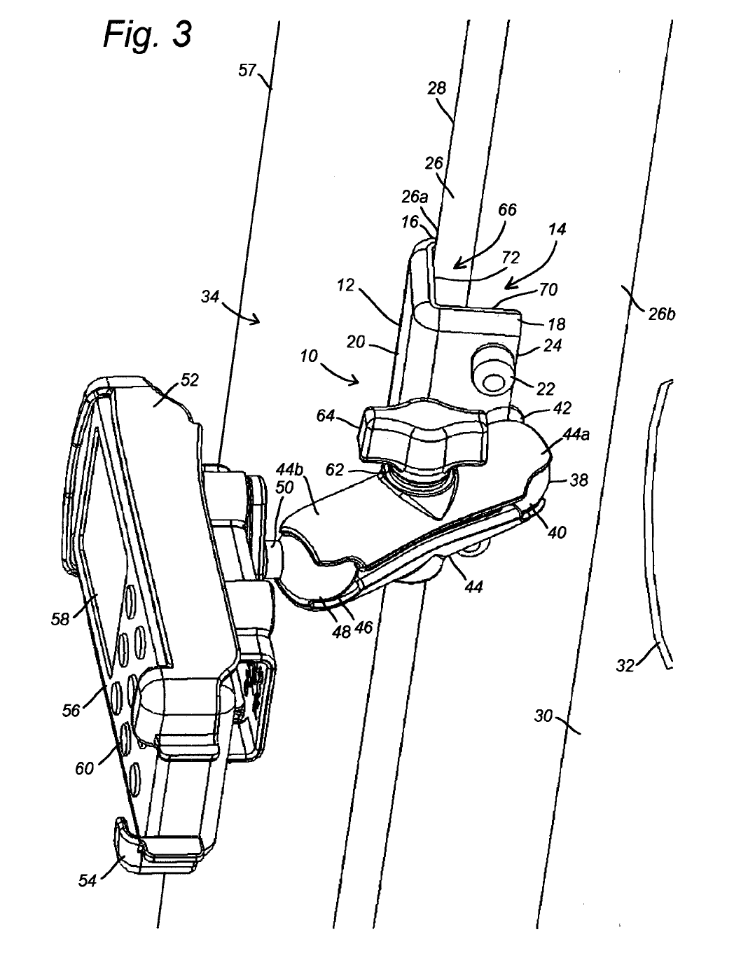

FIG. 3 is a bottom perspective view looking up at the clamp device 10 from the shadowed area 34 under the overhanging edge protrusion 26 of the cockpit dashboard 28. Here, the lower plate 18 is more clearly shown having the ball-end coupler 38 projected therefrom between the two spaced apart thumb screws 22.

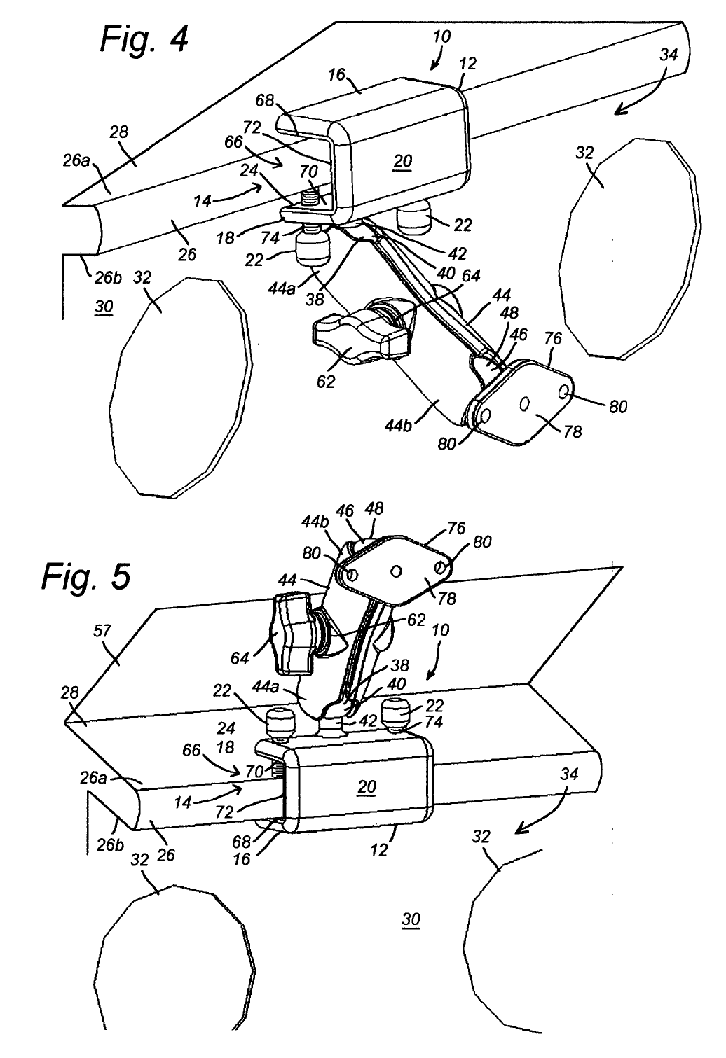

FIG. 4 is a perspective view showing the clamp device 10 mounted on the edge protrusion 26 of the cockpit dashboard 28 with the ball-end coupler 38 oriented downward into the shadowed area 34. The clamp device 10 is illustrated here in combination with the cooperating split-arm socket assembly 44 and second ball-end coupler 48, as described herein. Here, the second ball-end coupler 48 is projected from a generic mounting plate 76 structured with a substantially planar mounting surface 78 having spaced apart mounting holes 80 therethrough. Such mounting plates 76 may be used to mount the instrument tray 54, as illustrated herein by example and without limitation.

FIG. 5 is a perspective view showing the clamp device 10 mounted on the dashboard edge protrusion 26 with the ball-end coupler 38 oriented upward above the cockpit dashboard 28. This orientation may be appropriate, for example, for holding paper documents in a lighted portion of the cockpit outside the shadowed area 34 for easier reading.

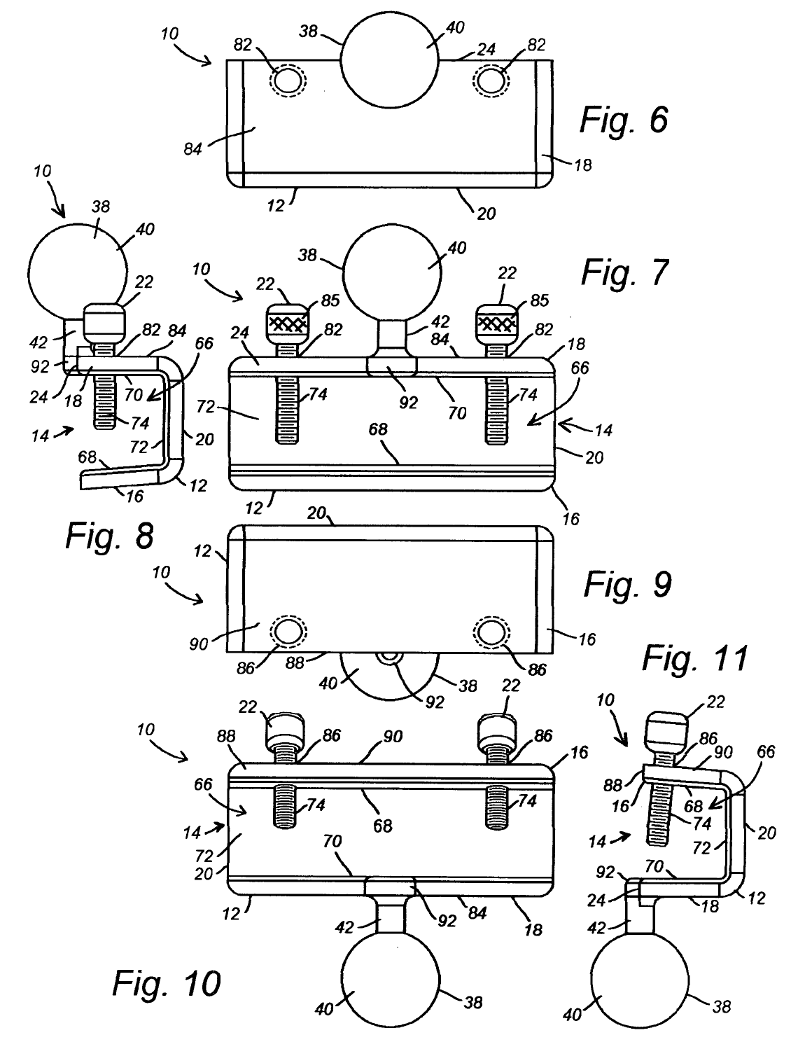

FIG. 6 is a top elevation view of the clamp device 10 wherein the thumb screws 22 are removed to more clearly show a pair of threaded holes 82 spaced apart along the outer lip portion 24 of the lower jaw plate 18 of the elongated jaw portion 12. The threaded holes 82 extend through the lower jaw plate 18 between a substantially planar outer surface 84 and the inner surface 70. The thumb screws 22 are threaded into the mouth opening 14 through the threaded holes 82 of the lower jaw plate 18. However, as discussed herein above, the thumb screws are optionally provided through the upper jaw plates 16 wherefore the threaded holes 82 are rather formed through the upper jaw plate 16, without deviating from the scope and intent of the present invention.

FIG. 7 is a back elevation view of the clamp device 10 wherein the thumb screws 22 are spaced apart on opposite sides of the ball-end coupler 38. As illustrated here, the threaded shafts 74 of the thumb screws 22 are optionally sized shorter than the mouth opening 14 when threaded through the lower jaw plate 18. The intended use of the novel clamp device 10 is for being fitted over the edge protrusion 26. The edge protrusion 26 has a finite minimum thickness. Therefore, the thumb screws 22 do not need to span the entire width between the upper and lower jaw plates 16, 18. Rather, the thumb screws 22 need only reach far enough to engage the edge protrusion 26 for securing the clamp device 10 thereto. Accordingly, thumb screws 22 with threaded shafts 74 shorter than the full span of the throat 66 project less above the jaw plate 18 external of the jaw portion 12 than would longer thumb screws 22. Thus, although threaded shafts 74 of the thumb screws 22 shorter than the full span of the throat 66 are not a necessary requirement of the clamp device 10, such feature ensures the most streamlined structure relative to the jaw portion 12.

Furthermore, in contrast to the square power threads and T-handle typical of C-clamps and vices, the thumb screws 22 are conventional thumb screws having the shafts 74 threaded with ordinary unified standard screw threads. Heads 85 of the thumb screws 22 are optionally formed with knurling or another anti-slip configuration typical of conventional thumb screws.

FIG. 8 is a side elevation view of the clamp device 10. Here, the jaw portion 12 is illustrated as having the upper jaw plate 16 being nonparallel or angularly canted relative to the lower jaw plate 18 which is substantially square with the backing plate 20. Alternatively, only the substantially planar inner surface 68 of the upper jaw plate 16 is angularly canted relative to the inner surface 70 of the lower jaw plate 18. Accordingly, the mouth opening 14 is wider than the inner surface 72 of the backing plate portion 20. The throat portion 66 thus forms a shallow right triangle truncated at its narrow end by the backing plate 20. Optionally, both the upper and lower jaw plates 16, 18 are canted relative to the backing plate 20 such that they form an isosceles triangle truncated at its narrow end by the backing plate 20.

Furthermore, the thumb screws 22 are position adjacent to the outer lip portion 24 of the lower plate 18, which permits the clamp device 10 to engage and grip even narrow ledges that may not be deep enough to reach the backing plate 20.

FIG. 9 is a bottom elevation view of the clamp device 10 showing the resiliently deformable part-spherical head 40 of the ball-end coupler 38 over the upper jaw plate 16. Here, the upper jaw plate 16 of the elongated jaw portion 12 optionally includes another pair of threaded holes 86 spaced apart along an outer lip portion 88 of the upper jaw plate 16. The threaded holes 86 extend through the upper jaw plate 16 between a substantially planar outer surface 90 and the inner surface 68. Optionally, the thumb screws 22 are threaded into the mouth opening 14 through the optional threaded holes 86 of the upper jaw plate 16, whereby the upper jaw plate 16 operates as the drive plate, while the lower jaw plate 18 operates as the anvil. The pair of threaded holes 86 through the upper jaw plate 16 of the elongated jaw portion 12 are optionally provided either in combination with the threaded holes 82 through the lower jaw plate 18, or in lieu of the threaded holes 82. Thus, elongated jaw portion 12 optionally has either one or both pair of the threaded holes 82 and 86 through the respective lower and upper jaw plates 18 and 16, without departing from the spirit and scope of the invention.

Additionally, as illustrated here by example and without limitation, the lower plate 18 further includes a small ledge protrusion 92 projected from the outer lip portion 24 substantially coplanar therewith and approximately centered relative to both the mouth opening 14 and the threaded holes 86. The reduced diameter stem 42 is formed with approximately one-half its diameter on the outer lip portion 24 of the lower plate 18, and one-half on the small protrusion 92. Positioning the stem 42 partially on the protrusion 92 causes the ball-end coupler 38 to be partially extended beyond the outer lip portion 24 of the lower plate 18, which effectively increases displacement of the ball-end coupler 38 as far as possible into the shadowed area 34 cast by the edge protrusion 26 of the cockpit dashboard 28. The small protrusion 92 beyond the outer lip portion 24 of the lower plate 18 is not a necessary requirement of the clamp device 10; however, such feature ensures the most extreme relative positioning the ball-end coupler 38 relative to the jaw portion 12.

FIG. 10 is a back elevation view of the clamp device 10 wherein the upper jaw plate 16 is structured having the optional pair of threaded holes 86 therethrough, either in combination with, or in substitution for, the threaded holes 82 through the lower jaw plate 18. Here, the thumb screws 22 are threaded through the optional pair of threaded holes 86. The thumb screws 22 are thus in the upper jaw plate 16 opposite from the ball-end coupler 38.

FIG. 11 is an opposite side elevation view of the clamp device 10 having the thumb screws 22 are threaded through the optional pair of threaded holes 86 in the upper jaw plate 16 opposite from the ball-end coupler 38.

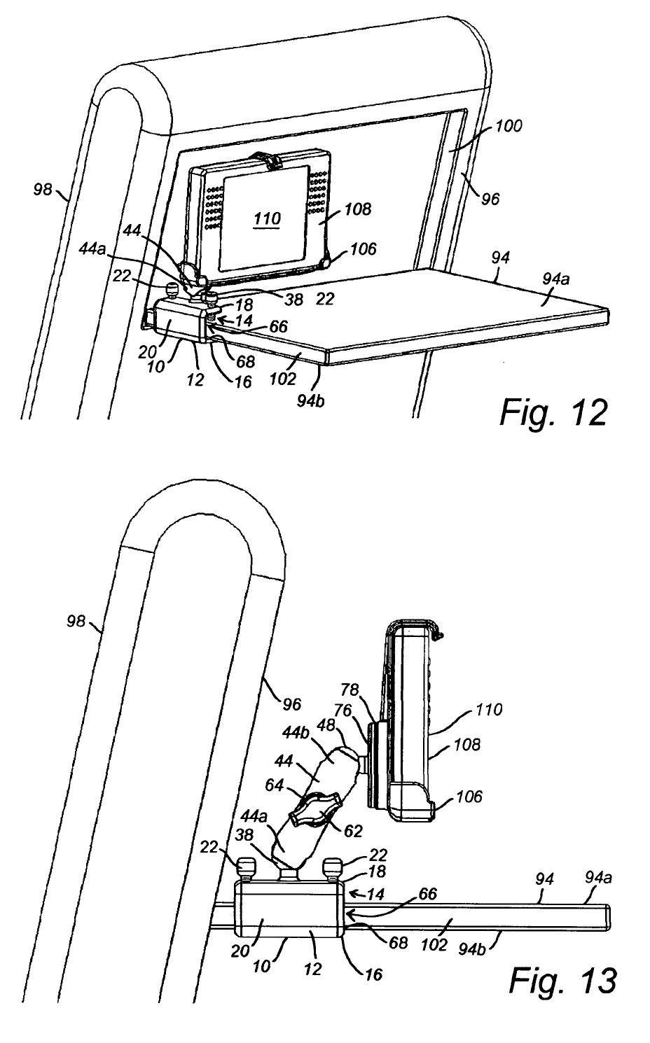

FIG. 12 illustrates another method of operating the clamp device 10 as an aviation clamp. Here, the clamp device 10 is secured to a fold-out tray table 94 in a deployed configuration relative to a seat back 96 of a forward seat 98, for example an airplane seat, although the this is optionally the forward seat of a modern automobile or pleasure boat. Such a fold-out tray table 94 is often sized to seat at least partially within a complementary recess 100 formed in the seat back 96. The mouth opening 14 and throat 66 of the jaw portion 12 is fitted over an edge portion 102 of the tray table 94, which is illustrated in this example in a folded-out configuration. The clamp device 10 is oriented here by example and without limitation with the ball-end coupler 38 extended above a working surface 94a of the tray table 94. The thumb screws 22 secure the clamp device 10 in position by squeezing the inner surface 68 of the upper jaw plate 16 against a backside 94b of the tray table 94. For example, the clamp device 10 is used in combination with the combination with the cooperating split-arm socket assembly 44 and second ball-end coupler 48, as described herein, to hold another instrument tray 106 holding another portable electronic instrument 108, such as a portable computer or DVD player for in-flight viewing of its display screen 110.

FIG. 13 is a front view of the clamp device 10 secured by the thumb screws 22 to the edge portion 102 of the deployed fold-out tray table 94, as described herein above. The clamp device 10 is illustrated here by example and without limitation as cooperating with the split-arm socket assembly 44 and second ball-end coupler 48, as described herein, for holding instrument tray 106 for in-flight viewing of the portable electronic instrument 108.

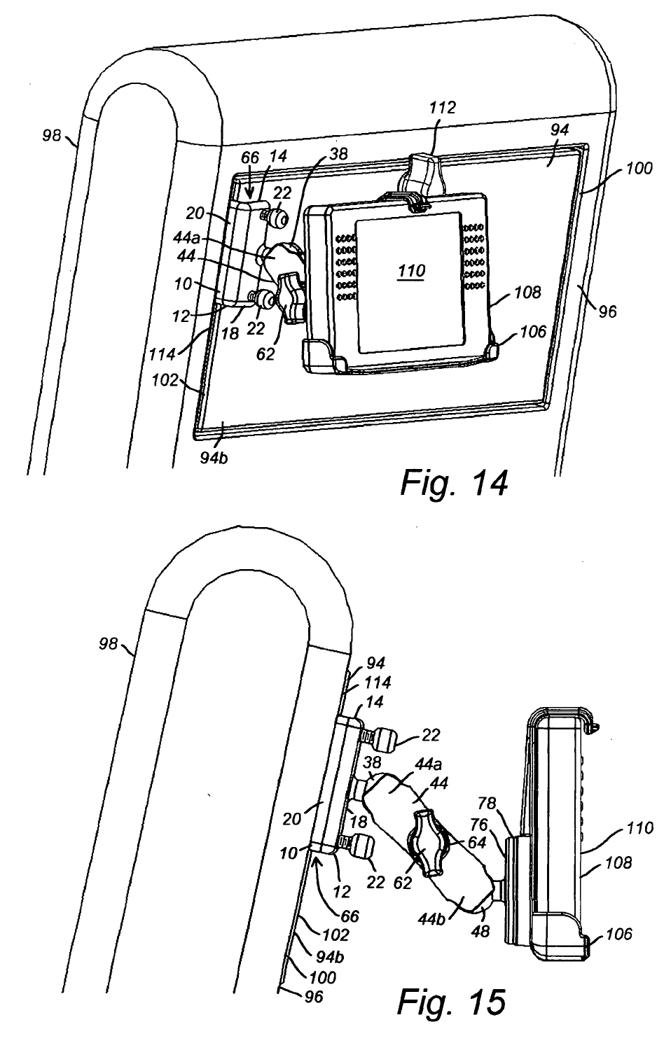

FIG. 14 illustrates yet another method of operating the clamp device 10 as an aviation clamp. Here, the clamp device 10 is secured to the fold-out tray table 94 stored in an upright and locked configuration relative to the seat back 96 of the forward seat 98, for example an airplane seat, although the this is optionally the forward seat of a modern automobile or pleasure boat. The mouth opening 14 of the jaw portion 12 is fitted over the edge portion 102 of the tray table 94. Here, the clamp device 10 is oriented here by example and without limitation with the ball-end coupler 38 extended above the backside surface 94b of the tray table 94. The thumb screws 22 secure the clamp device 10 in position by squeezing the inner surface 68 of the upper jaw plate 16 against the working surface 94a of the tray table 94. Here, the novel shape of the jaw portion 12 of the clamp device 10 is used to good advantage. As discussed herein, the upper plate 16 is slim to fit into narrow passages. Here, the slim upper plate 16 is thin enough that it does not interfere with closure of the tray table 94 against the seat back 96 of the forward seat 98, and even permits securing a tray table locking knob 112, while in the clamp device 10 remains secured to the tray table edge portion 102.

Furthermore, as discussed herein, the backing plate 20 is slender such that it fits in a narrow gap 114 between the tray table edge portion 102 and the seat back 96 when the tray table 94 is fit into the complementary recess 100. A conventional C-clamp design does not permit closure of the tray table 94 into the confined space of the complementary recess 100. Rather, conventional C-clamp type devices generally have a thin flat anvil plates disposed on a thick stiffener formed by a heavy strong back between the anvil and the threaded drive head holding the threaded drive rod. Typically, the strong back must be thick to adequately support the force generated by the drive rod. Here, the thumb screws 22 are conventional thumb screws, in contrast to the square power threads and T-handle typical of C-clamps and vices. The threaded shafts 74 of the conventional thumb screws 22 have ordinary unified standard screw threads and knurled heads 85 (more clearly shown in earlier Figures). Optionally, the thumb screws 22 are plastic or nylon screws to avoid scratching clamping surfaces. Thus, the forces generated by tightening the thumb screws 22 are minimal as compared with conventional C-clamp devices because the clamp device 10 is expected to support minimal loads.

Thus, the clamp device 10 is used in combination with the combination with the cooperating split-arm socket assembly 44 and second ball-end coupler 48, as described herein, to hold the portable computer, DVD player or other portable electronic instrument 108 in the instrument tray 106 with its display screen 110 positioned for in-flight viewing, even when the tray table 94 is stored in its upright and locked position relative to the seat back 96.

FIG. 15 is a front view of the clamp device 10 secured by the thumb screws 22 to the edge portion 102 of the tray table 94 while stored in its upright and locked position relative to the seat back 96, as described herein above. The clamp device 10 is illustrated here by example and without limitation as cooperating with the split-arm socket assembly 44 and second ball-end coupler 48, as described herein, for holding instrument tray 106 for in-flight viewing of the portable computer, DVD player or other portable electronic instrument 108.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A clamp device, comprising:
a substantially rigid elongated jaw structure formed with an elongated mouth opening thereinto formed between opposing drive and anvil plates spaced apart by an opposing backing plate, the drive plate being formed with a plurality of threaded apertures therethrough spaced along the mouth opening, and a ball-end coupler projected from one of the drive and anvil plates; and
a plurality of threaded fasteners each structured for threading through one of the threaded apertures.

2. The device of claim 1 wherein the ball-end coupler further comprises a resiliently deformable part-spherical head formed on a substantially rigid reduced diameter stem relatively upstanding on the one of the drive and anvil plates.

3. The device of claim 2 wherein the stem portion of the ball-end coupler is formed adjacent to a lip portion of the one of the drive and anvil plates adjacent to the mouth opening.

4. The device of claim 3 wherein the stem portion of the ball-end coupler is formed substantially centered relative to the mouth opening.

5. The device of claim 4 wherein the one of the drive and anvil plates having the ball-end coupler projected therefrom further comprises a protrusion projected from the lip portion thereof both substantially coplanar therewith and substantially centered relative to the mouth opening; and
the stem portion of the ball-end coupler is formed partially on the lip portion and partially on the protrusion projected therefrom.

6. The device of claim 5 wherein two or more of the plurality of threaded apertures are further formed adjacent to a lip portion of the drive plate.

7. The device of claim 6 wherein the ball-end coupler is formed on the drive plate.

8. The device of claim 6 wherein the ball-end coupler is formed on the anvil plate.

9. The device of claim 6 wherein the drive and anvil plates are further relatively angularly canted.

10. A clamp device, comprising:
a substantially rigid elongated jaw structure formed with an open throat portion formed between spaced apart and relatively angularly canted opposing drive and anvil plates and a backing plate and having an elongated mouth opening thereinto between the opposing drive and anvil plates and partially extending around peripheries thereof to the backing plate, the drive plate being formed with a pair of threaded apertures therethrough spaced adjacent to opposite ends thereof, and a ball-end coupler formed of a resiliently deformable part-spherical head projected from one of the drive and anvil plates on a substantially rigid reduced diameter stem relatively upstanding thereon; and
a plurality of threaded thumb screws each structured for cooperating with one of the threaded apertures by threading therethrough from an external surface of the elongated jaw structure into the throat portion thereof.

11. The device of claim 10 wherein the stem portion of the ball-end coupler is formed adjacent to a lip portion of the one of the drive and anvil plates adjacent to the mouth opening and substantially centered relative thereto.

12. The device of claim 11 wherein the drive and anvil plates further comprise substantially planar opposing interior surfaces.

13. The device of claim 12 wherein the drive and anvil plates further comprise substantially identical uniformly long, flat and relatively thin rigid plates.

14. The device of claim 13 wherein the backing plate further comprises a uniformly long, flat and relatively thin rigid plate substantially identical to the drive and anvil plates.

15. The device of claim 13 wherein the one of the drive and anvil plates having the ball-end coupler projected therefrom further comprises a protrusion projected from the lip portion thereof both substantially coplanar therewith and substantially centered relative to the mouth opening; and
the stem portion of the ball-end coupler is formed partially on the lip portion and partially on the protrusion projected therefrom.

16. The device of claim 15 wherein two or more of the plurality of threaded apertures are further formed adjacent to a lip portion of the drive plate.

17. The device of claim 16 wherein the ball-end coupler is formed on the drive plate.

18. The device of claim 16 wherein the ball-end coupler is formed on the anvil plate.

19. A method of mounting an external object for viewing, the method comprising:
fitting an elongated throat portion of a substantially rigid elongated jaw structure over an edge protrusion having opposing first and second surfaces spaced apart by a thickness less than an elongated opening into the throat portion, including positioning a substantially rigid anvil plate adjacent to a first surface of the edge protrusion, and positioning a rigidly interconnected opposing substantially rigid drive plate adjacent to a second surface thereof substantially opposite from the first surface, one of the drive and anvil plates having a first ball-end coupler projected therefrom and formed of a substantially rigid reduced diameter stem relatively upstanding thereon and a resiliently deformable part-spherical head formed on the stem distal from the jaw structure;
from an exterior surface of the drive plate opposite from the first surface of the edge protrusion, threading at least two threaded fasteners through cooperating threaded apertures formed in the drive plate and into contact with the first surface of the edge protrusion;
on an external object, mounting a second ball-end coupler having a relatively upstanding substantially rigid reduced diameter stem with a resiliently deformable part-spherical head formed thereon distal from the external object;
on the respective part-spherical heads of the first and second ball-end couplers, rotatably coupling respective first and second socket ends of a split-arm socket assembly;
rotatably adjusting a position and orientation of the external object for positioning a viewable portion thereof in a position suitable for viewing; and
by tightening a clamping mechanism relative to the split-arm socket assembly, interlocking each of the first and second socket ends with the respective part-spherical heads of the first and second ball-end couplers for retaining the selected positioning.

20. The method of claim 19 wherein mounting a second ball-end coupler on an external object further comprises mounting the second ball-end coupler on a tray structured for holding a portable electronic instrument having a lightable display screen.

21. The method of claim 20 wherein fitting an elongated throat portion of a substantially rigid elongated jaw structure over an edge protrusion further comprises fitting the elongated throat portion over an edge protrusion of a cockpit dashboard.

22. The method of claim 21 wherein rotatably adjusting a position and orientation of the external object for positioning a viewable portion thereof in a position suitable for viewing further comprises positioning the external object relative to the cockpit dashboard opposite from one or more windscreens of a cockpit containing the dashboard.

23. The method of claim 22 wherein the cockpit dashboard further comprises a first surface adjacent to the one or more windscreens and a second surface opposite and spaced away from therefrom, the first surface of the cockpit dashboard further comprising the first surface of the edge protrusion, and the second surface of the cockpit dashboard further comprising the second surface of the edge protrusion;
with the drive plate further comprising the first ball-end coupler projected therefrom and the threaded fasteners being threaded into the cooperating threaded apertures formed therein, orienting the elongated jaw structure with the anvil plate adjacent to the first surface of the edge protrusion adjacent to the one or more windscreens, and the drive plate and the first ball-end coupler projected therefrom the adjacent to second surface of the edge protrusion opposite and spaced away therefrom; and
threading the threaded fasteners through the cooperating threaded apertures formed in the drive plate and into contact with the second surface of the edge protrusion.

24. The method of claim 20 wherein fitting an elongated throat portion of a substantially rigid elongated jaw structure over an edge protrusion further comprises fitting the elongated throat portion over an edge protrusion of a table.

25. The method of claim 24 wherein fitting an elongated throat portion of a substantially rigid elongated jaw structure over an edge protrusion further comprises fitting the elongated throat portion over an edge protrusion of a tray table structured for folding relative to a seat back of a vehicle seat.

26. The method of claim 25 wherein the tray table further comprises a first surface facing generally toward the seat back and a second surface opposite from the first surface and facing generally away from the seat back, the first surface of the foldable tray table further comprising the first surface of the edge protrusion, and the second surface of the foldable tray table further comprising the second surface of the edge protrusion;
with the drive plate further comprising the first ball-end coupler projected therefrom and the threaded fasteners being threaded into the cooperating threaded apertures formed therein, orienting the elongated jaw structure with the anvil plate adjacent to the first surface of the edge protrusion facing generally toward the seat back, and the drive plate and the first ball-end coupler projected therefrom the adjacent to second surface of the edge protrusion opposite and spaced away therefrom and facing generally away from the seat back;
threading the threaded fasteners through the cooperating threaded apertures formed in the drive plate and into contact with the second surface of the edge protrusion;
folding the foldable tray table relative to the seat back with the first surface of the foldable tray table facing inwardly toward and in substantially contact with the seat back, and the second surface thereof facing outwardly therefrom; and
securing the foldable tray table relative to the seat back with the drive plate further comprising the first ball-end coupler projected therefrom substantially outwardly of the second surface of the foldable tray table and external of the seat back.

27. The method of claim 26 wherein the seat back further comprises a recess formed therein, the recess being sized to admit the tray table thereinto with external peripheral edges thereof being spaced away from internal peripheral edges of the recess;
the tray table further comprises a tray table foldable into the recess formed in the seat back with first surface facing generally toward the seat back and fitting into the recess formed therein and the second surface opposite from the first surface and facing generally away from the seat back;
folding the foldable tray table relative to the seat back further comprises folding the foldable tray table into the recess formed in the seat back with the first surface of the foldable tray table facing into the recess, and the second surface thereof facing outwardly therefrom, the anvil plate being positioned in the recess between the first surface of the tray table and an opposing surface of the seat back, and a backing plate of the elongated jaw structure between the drive and anvil plates thereof being positioned between the external peripheral edges of the foldable tray table and the internal peripheral edges of the recess; and
securing the foldable tray table relative to the seat back further comprises securing the foldable tray table substantially within the recess.
